(19) United States
(12) Patent Application Publication
(10) Pub. No.: US 2004/0015822 A1
(43) Pub. Date: Jan. 22, 2004

(54) Method and apparatus for dynamic assembly and verification of software components into flexible applications

(76) Inventors: Samuel W. Linton, Sunnyvale, CA (US); John W. Wallerius, Sunnyvale, CA (US); Myles A. Sussman, Sunnyvale, CA (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/816,797

(22) Filed: Mar. 23, 2001

(51) Int. Cl. G06F 9/44

(52) U.S. Cl. 717/104; 717/108; 717/116

(57) ABSTRACT

A method and apparatus for assembling software components into an application. In an embodiment, the apparatus generally relates to an application creator which assembles software modules at run time into a container application. The container application supports interface inheritance and implementation inheritance from an existing software component.

### FIELD OF THE INVENTION

This invention generally relates to component software engineering. More specifically the invention relates to a method and apparatus for assembling software components into an application.

### BACKGROUND OF THE INVENTION

Introduction

Object Oriented Programming (OOP), and Microsoft's Component Object Model (COM) are related technologies which aid in the assembly of software applications. COM and OOP were developed to deal with the problem of increasing software complexity and to make extensions to existing software as easy as possible. A software architecture should support extensibility to allow future improved versions of applications and to facilitate the process of developing complex software products by teams of programmers. In addition, a software architecture should allow third-party developers to reuse existing software and to add functionality to existing applications. In any of these scenarios, the overall productivity of software programmers may increase if the need for programmers to “re-invent the wheel” by implementing their own version of software functionality is reduced or eliminated.

Object Oriented Programming

In the industry's attempt to manage complexity, maintain flexibility and facilitate code reuse, Object Oriented Programming (OOP) has become an industry standard. C++ and Java are commonly used languages that are designed to support OOP, though other languages (such as Smalltalk) exist as well. In OOP, the basic construct is the class. A class is a collection of data or attributes as well as functions or methods. A software class may represent a type of physical object or the software class may just be a convenient grouping of logically related functionality and data. A specific instance of a class is known as an object. As an example of the use of object-oriented programming, consider a simulation of a simple wireless network as shown in FIG. 1.

FIG. 1 illustrates an embodiment of a simulation of a wireless network including a first class, a base-station, a second class, a handheld mobile, and a third class, a link. The physical elements in the wireless network 100 are the base-station 102 and the handheld mobile 104. In an embodiment of OOP implementation, a first class represents the base-station 102. A second class represents the handheld mobile 104. In addition to these two classes representing the physical components of the wireless network 100, the software designer might choose to represent the connection between the base-station and the mobile 104 handset with a third class, a link 106. A link 106 would be used to monitor and manage the wireless connection between the two other classes.

OOP has several advantages over the procedural programming that OOP replaced. First of all, OOP supports encapsulation and data hiding. This means that the classes in the software can have internal attributes and functions that are hidden from external view. Only a limited, carefully planned subset of functions (and possibly attributes) is exposed for use by external classes. This exposed subset constitutes the interface for the class. The advantage of this is that the internal hidden implementation of the class may change without the interface changing. This means that changes to code of the class have minimum impact outside of that class.

As an example, refer to the simple wireless network 100 described in FIG. 1. Let us assume that the second class representing the mobile 104 has attributes representing the position of the mobile 104. Assume that in an initial implementation, the position was stored in x and y coordinates (given in kilometers) representing the displacement from some reference point. However, these attributes themselves are not directly accessible to external users of the class. The position can be retrieved only with a function of the class (GetPosition, for example). Now let us further assume that a better representation for the position of the mobile 104 is in the mobile's latitude and longitude coordinates. Because the client code does not use the position attributes of the mobile 104 directly, the old scheme of x and y values can be replaced with latitude and longitude coordinates, as long as the GetPosition function still returns the desired values. Thus, we have an example in which the implementation of the second class changed, but because the interface to the second class remained the same, the client code need not be changed. In large, complex software projects, this property is very helpful.

Another feature of OOP is inheritance. If a derived class B inherits from a base class A, class B inherits all the attributes and functions of A. In the traditional terminology, we say that B has an “is-a” relationship with A. An example would be if a software Car class derived from a software Vehicle class. The Car class takes advantage of all of the attributes (such as location and speed), and functions (such as UpdatePosition) of the Vehicle, but may add data and functions appropriate to the Car class (such as make and model). In this kind of inheritance, both the interface and the implementation are inherited, though functions may be overridden (replaced) in the derived class.

The inheritance mechanism is needed to support the next major feature of OOP, called Polymorphism. Polymorphism allows client code to use derived classes as if they were base classes. As a matter of fact, the client code need not be aware of the existence any of the derived classes. The client code may call any of the functions declared in the base class's interface. If the derived class chooses to override the implementation of functions defined in the base class, then the overridden (derived class) function is called instead of the base class function. Thus, polymorphism allows the addition of new derived classes with new functionality. The only constraint is that the client code is only aware of the interface defined by the base class.

The advantages of inheritance and polymorphism are several. First of all, implementation inheritance is an effective code reuse mechanism. Default implementations of functions defined in the base class interface are automatically included in the derived class, unless they are explicitly overridden. The programmer of the derived class may concentrate on the new functionality of the derived class, rather than having to recreate the functionality of the base class. Secondly, with polymorphism, the client code need not know anything about the type of the derived class. This means that the new derived class can be added to the client code with minimal rewriting of the client code. Finally, with interface and implementation inheritance, the software designer can add to the interface and implementation of the base class, and this will automatically be incorporated into the derived classes, with no new coding necessary.

Object Oriented Programming Shortcomings

For all its advantages, OOP as implemented by languages such as C++ and Java has several disadvantages.

The first problem is a result of the hierarchical structure used for polymorphism as a mechanism for extending functionality to derived classes. The paradigm enforced by (single) inheritance can be represented by a tree structure. Each derived class inherits all the characteristics (meaning interface definition and attributes) of the base class, and adds some of its own. Other classes derived from the same base class (siblings of the first class), share only the characteristics of their common base class, and none of the characteristics they each individually added. This result is often inadequate, when the goal is to allow third party developers to add functionality in a flexible and unpredictable way to the software.

As an illustration, consider the simple wireless network 100 example described in FIG. 1. Consider the second class representing the mobile 104. Assume that other software engineers wish to create classes that extend the mobile 104 class while reusing the basic functionality of the second class. In particular, assume that a mobile 104 is being modeled that uses some sort of power control. The engineer might achieve this by creating a second class, MobileWithPowerControl, derived from the original first class, Mobile 104. This provides the benefits of code reuse and transparency of type from the perspective of the client application. Now assume that at the same time, a second engineer creates a third class, MobileWithFrequencyHopping, also derived from the second class representing the mobile 104. This new class adds a frequency hopping behavior to the base class mobile 104 functionality. The problem comes when we would like to have a mobile 104 that supports both power control and frequency hopping. Currently no way exists to “blend” the two derived classes using standard OOP. Instead, a new class would have to be created (say, MobileWithPowerControlAndFrequencyHopping) that combines both power control and frequency hopping. This new class could be derived either from MobileWithPowerControl with frequency hopping functionality added, or from MobileWithFrequencyHopping, with the power control functionality added. In either case, we have lost the benefit of some code reuse. Further, if the replicated code changed in one location, then a maintenance nightmare exists to insure that the replicated code changed wherever the replicated code appeared. In addition, the inability to blend the additions of functionality of derived classes causes proliferation with each derived class having a different subset of added functionality. The proliferation becomes even more acute as more functionality is added later.

There are certainly ways to deal with the above described problem using OOP. One method is to use multiple inheritance, in which a derived class is derived from more than one base class. A software engineer might create a separate FrequencyHopping base class that encapsulates the frequency hopping functionality by itself. Classes derived from the mobile class could “mix-in” the frequency hopping functionality by deriving from the FrequencyHopping class as well. This addresses the code reuse problem. However, we still have the issue of the proliferation of derived mobile classes. Furthermore, the need for coupling between the multiple base classes is likely to complicate the design and usage of the classes. A second strategy would be to have the mobile class “own” a set of abstract behaviors. The frequency hopping and power control behaviors could be derived from a base class for all behaviors. This would allow a great deal of flexibility and extensibility for the mobile class. The problem with this is that the base class's interface would have to be well known and would be fixed and inflexible.

The second problem with OOP is that OOP is a compile-time reuse mechanism. For derived classes to be compiled and linked in a software application, there must be access to the base class's code either as source code or as a compiled code with matching header files. Compile-time reuse greatly complicates updating of the base class code. Whenever a base class is updated, whether by fixing bugs or by adding functionality, the application using the code must also be rebuilt. When many different software engineers are re-using the underlying software, this becomes a maintenance nightmare. The need to rebuild derived applications makes software engineers reluctant to make changes to the software, and tends to discourage the adoption of newer versions of the code being reused.

A third problem with modern OOP applications deals with the persistence of their data. In general, a user should be able to save the state of an application so that the user may quit the application and return to the application at a later time. This is traditionally done by saving data representing the state of the application to a binary or textual file. Unfortunately, as the application evolves from version to version, the information that is saved in the file changes. The software engineer must use extreme care to ensure that the new version of the application will be able to detect and translate the old version of the file. Usually, the files saved by new versions of the application are simply not readable by old versions of the application. The usual way of addressing this problem is to have new versions of the application have the ability to save their state in the old version of the file. This of course represents a nightmare in software maintenance and a headache for the users.

In OOP the fundamental unit of software is the class, which is an encapsulation of attributes (or data) and functions (or operations) that work with that data. One key aspect of OOP is the ability of a class (the derived class) to inherit from one (or more) other classes (the base classes). The derived class is said to have an “is-a” relationship with its base object. In this scenario, the derived class automatically inherits all the functions defined in the base class. This inheritance includes the base object interface (called interface inheritance), as well as the base class's implementation of the interface (called implementation inheritance). The derived class may either retain the base class implementations of the functions defined in the base class simply by not redefining them, or the derived class may selectively override individual function implementations. There are two major benefits to implementation inheritance available in OOP. The first is that implementation inheritance is an effective method of code reuse. The authors of derived classes need not re-implement all the functionality within the base class. Indeed, they need not even have access to that code. The second benefit to implementation inheritance is due to the fact that if function definitions and their implementations are added to the base class interface, these functions are automatically available to users of all the classes derived from that base class. Thus, functionality can be added to all derived classes without the involvement of the authors of the derived classes. Due to the nature of OOP code re-compilation may be necessary.

Component Software Architecture

Modem software applications commonly use software component technology. The software components are separately built components that can be linked in with the application at run time. The software components each typically provide specific functionality for the main application. The main application or other components access these software components through their interfaces, which define the services implemented by the component, and define the method of using them. The software components are traditionally installed on the computer on which the main application is hosted (though they may also reside on remote computers accessed via a computer network). The software components are linked into the application as needed at run-time. This strategy is implemented using technologies designed for that purpose such as the Component Object Model (COM). The purposes of this strategy are to:

1) Manage the complexity of the software application by breaking the required tasks into well-defined subtasks, each of which is implemented by separately buildable components.

2) Handle versioning by allowing older components to be replaced by new components that perform the same task, but in an updated or improved way. Because the components are linked into the application at run-time, it is not necessary to rebuild the client application. Note that the replacement components must implement the same interface as the old components.

3) Facilitate the reuse of software by allowing application developers to reuse components with published interfaces in their own applications or components. Note that the consumer of the component must have complete knowledge of the existing component's interface definition in order to use it.

Typically, the component software architecture is used to manage complexity within an application, allow versioning strategy, and to develop components or controls that can be reused by other software applications or components.

Component Software Architecture Shortcomings

Despite the power and benefits of the software component strategy, it has its limitations. In particular, object-oriented programming (OOP), a dominant technology in modern software, is not fully supported by most component architectures such as COM. Further, COM only supports interface inheritance, but not implementation inheritance. This means that software components implementing derived objects must provide all their own implementations for all the functions in the inherited interface.

A second problem with the component software architecture is that component software architecture is based on the assumption that the component interfaces are immutable. This requirement is necessary of course to allow different versions of software components to communicate correctly. The effect is that the interface of a base class should never be changed. The component software solution to the need for changed interfaces is to add or substitute a new extended interface to the class, rather than change the existing interface. Unlike in C++, i.e. OOP, new functions cannot be added to a base class that are transparently passed on to all the derived classes.

The users of component software architectures use two common approaches to attempt to recapture the benefits of implementation inheritance. The first approach is the use of containment/delegation. In this strategy, the derived class uses interface inheritance, and also contains an instance of the base class. To simulate the inheritance of a function's implementation, the derived class's implementation of the function consists of calling the base class's equivalent function (called delegation). This approach has several problems. First of all, implementing the delegation function is inconvenient and error-prone. Secondly, there is no way to add functionality to the base classes that will transparently be reflected in the derived classes without recoding the derived classes. The derived class has been coded assuming a specific, fixed interface in the base class.

A second approach to simulate implementation inheritance is the use of aggregation. In this strategy, an outer, “derived” class aggregates one or more internal “base” classes. Requests for the interface defined and implemented in the base class pass directly to an instance of the base class itself. With blind aggregation, in which the outer class has no information about the interfaces defined by the inner class, this is an effective way to implement implementation inheritance for all the functions in the base class's interface. The implementation is relatively straightforward and not error prone. The base class interface can even be modified or augmented, and the derived class is automatically updated. The one major flaw is that the derived class cannot selectively override individual functions or groups of functions defined by the base class. This is a major drawback, since it violates the idea behind OOP.

An early idea was to combine the aggregation and containment/delegation. Base class functions that would be overridden would be in interfaces that contained/delegated, and those that would be reused by derived classes would be aggregated. But this requires an inflexible structure and a priori knowledge of what functions will need to be overridden.

### SUMMARY OF THE INVENTION

a method and apparatus for assembling software components into an application. In an embodiment, the apparatus generally relates to an application creator which assembles software modules at run time into a container application. The container application supports interface inheritance and implementation inheritance from an existing software component.

### BRIEF DESCRIPTION OF THE DRAWINGS

The drawings refer to the invention in which:

FIG. 1 illustrates an embodiment of a simulation of a wireless network including a first class, a base-station, a second class, a handheld mobile, and a third class, a link;

FIG. 2 illustrates an embodiment of the application creator;

FIG. 3 shows a detailed view of some of the parts of an embodiment of the container application;

FIG. 4 illustrates a detailed view of an embodiment of an element and an embodiment of a pattern;

FIG. 5 illustrates an embodiment of a hierarchal tree-structure of inter-related elements;

FIG. 6 illustrates a non-hierarchal arrangement of inter-related elements;

FIG. 7 illustrates an embodiment of a hierarchal tree-structure representing class derivations;

FIG. 8 illustrates a tree structure of the increment of interface and implementation provided by each class;

FIG. 9 illustrates a software component assembled from a catalog of all the available implementations of each interface;

FIG. 10 illustrates an overview of run-time software assembly and running of an embodiment of the container application; and

FIG. 11 illustrates detail of the running of an embodiment of a container application.

While the invention is subject to various modifications and alternative forms, specific embodiments thereof have been shown by way of example in the drawings and will herein be described in detail. The invention should be understood to not be limited to the particular forms disclosed, but not on the contrary, the intention is to cover all modifications, equivalents, and alternatives falling within the spirit and scope of the invention.

### DETAILED DISCUSSION

In an embodiment, the application creator extends existing software component technology to provide a new method of developing software applications that may be completely flexible, reusable, extensible, or versionless. In an embodiment, the application creator may allow the software designer to move away from the hierarchical tree-structure that results from traditional OOP techniques.

The host application may be a “container” application, into which other software modules could easily be plugged. Software modules can be written by the original parties or by other parties, based on a published Application Programming Interface (API). In an embodiment, the application creator uses component software technology to support the run-time linking of plug-in modules with the container application. The architecture used to assemble the application supports implementation inheritance and interface inheritance from existing software components

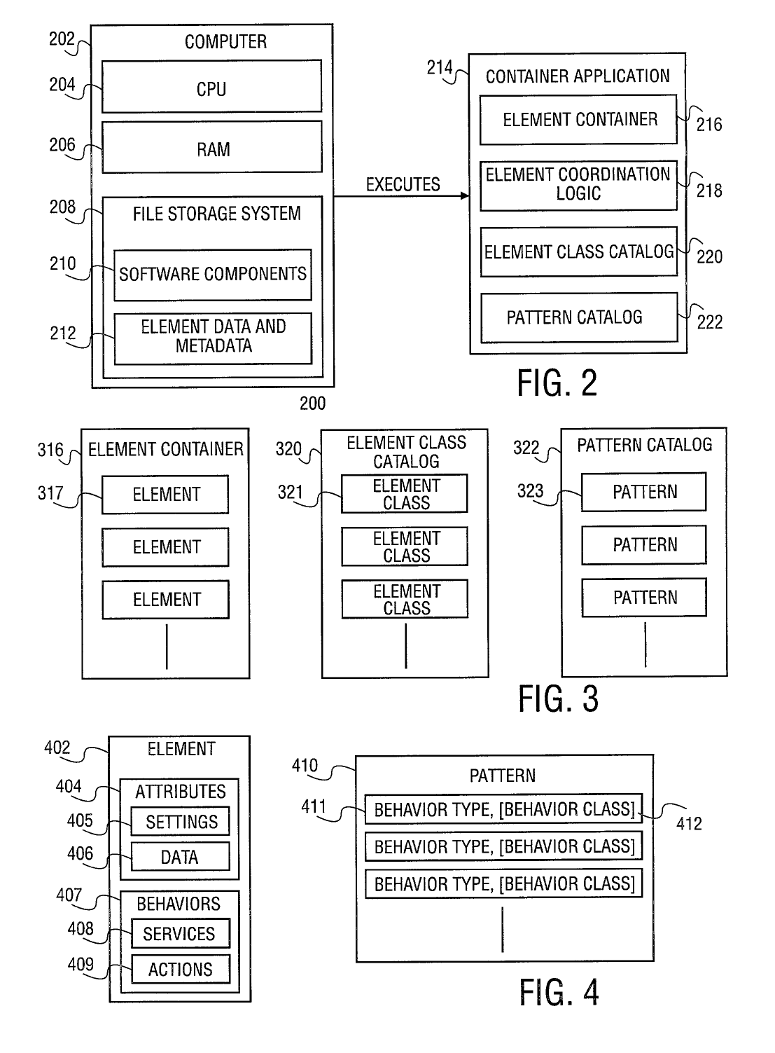

FIG. 2 illustrates an embodiment of the application creator. The application creator 200 is comprised of a computer 202 including a central processing unit (CPU) 204, random access memory (RAM) 206, and a file storage system 208. The file storage system 208 contains software components 210 and element data and metadata 212. A container application 214 is executed on the computer 202. The container application 214 is comprised of one or more element containers 216 and element coordination logic 218. The container application 214 may also include an element class catalog 220 that manages a list of all the element classes available to the container application 214. The container application 214 may also include a pattern catalog 222, that manages a list of all the patterns known to the application, and which is used by the application and elements in the application to get type information about the elements.

FIG. 3 shows a detailed view of some of the parts of an embodiment of the container application. The element container 316 contains a multiplicity of instances of elements 317, which are independent software components. The element class catalog 320 contains a multiplicity of distinct element classes 321. The pattern catalog contains a multiplicity of distinct patterns 323.

FIG. 4 illustrates a detailed view of an embodiment of an element and an embodiment of a pattern. The element 402 is the fundamental building block in the container application. Each element 402 may represent a specific object existing in the real world, so as to model the specific object, or the element 402 may represent a logically distinct set of functions usable by either the container application or other by elements. Each element 402 is comprised of a multiplicity of attributes 404 and behaviors 407. The multiplicity of behaviors 407 and attributes 404 in an element 402 can be implemented using any appropriate collection data structure appropriate to the language being used. Examples of possible data structures include arrays, lists and maps. In an embodiment, collection data structures from the Standard Template Library are used. Attributes 404 represent either data used by the element 402, part of the definition of the element 402, or the state of the element 402. Each attribute 404 is given an identity, such as a globally unique identifier (GUID) or a textual or string description. The attribute 404 can then be retrieved by reference to this name. An attribute 404 may be of two types: settings 405 are attributes 404 that are exposed to the container application's end-user, and are in general modifiable by him/her. Data attributes 406 are internal values that reflect the state of the element 402. Data attributes 406 are normally hidden from the end-user of the container application.

The behaviors 407 of an element 402 are components comprised of groups of functions that implement the required functionality of the element 402. Behaviors 407 may also have internal attributes and other behaviors. The behaviors 407 typically manipulate and use the data of the element 402. Each behavior 407 has a specific corresponding interface definition that is published. This interface defines the type of the behavior 407. Generally, the container application and other elements use this interface definition to use the behavior 407. In an embodiment, the Interface Definition Language (IDL) is used to define the interface of behaviors 407. Two behaviors 407 with the same type may be implemented differently, as long as they conform to the interface definition. A behavior's specific implementation of an interface type is known as its class. Note that a behavior's 407 interface may be derived from another interface or interfaces, potentially belonging to other behaviors 407. A behavior 407 instance exists when an instance of a specific class of behavior 407 is created for inclusion in the element 404.

Behaviors 407 can also be categorized as either services 408 or actions 409. Services 408 are behaviors 407 that have an interface of a specific type required to achieve known effects. When the container application requires the functionality of a service 408, the container application retrieves the appropriate service 408 interface from the element 404 and uses the functionality. A service 408 instance within an element 404 can be retrieved by referring to the identification tag of the corresponding specific type. In an embodiment, the identification tag may be a textual name, a globally unique identifier, or similar identification designator.

The second type of behavior 407 is the action 409. Unlike a service 408, all actions 409 implement the same interface (this includes the possibility of subclassing the action interface.) Thus, all actions 409 have the same base type, but are of differing classes. This allows the container application to use any action 409 of any element 404 without any predetermined knowledge of its functionality, since the interfaces are identical and well known. Multiple actions 409 with the same type may be contained within an element. In an embodiment, an action 409 instance within an element 404 can be retrieved by referring to the identification tag of the corresponding class. The identification tag may be a textual name, a globally unique identifier, or similar identification method.

FIG. 4 also has a detail of a pattern 410. A pattern 410 is a multiplicity of pairs of behavior types 411 and optionally corresponding behavior classes 412. A pattern 410 may be a behavioral pattern, an attribute pattern, or another similar pattern. A behavioral pattern may be a collection of behavior types 411. In an embodiment, a behavioral pattern may be a collection of behavior types 411 and corresponding behavior classes 412. An element 402 conforms to or matches the pattern 410 if the element 402 contains all of the behavior types 411 and behavior 412 classes specified in the pattern 410. A pattern 410 may specify behavior types 411 and n o behavior 412 classes, both behavior types 411 and the corresponding classes, service types, or some service type and classes. In an embodiment, an element 402 may be checked against a pattern 410 to ensure that a first element will interact appropriately with a second element. An attribute pattern is comprised of a list of required attributes 404.

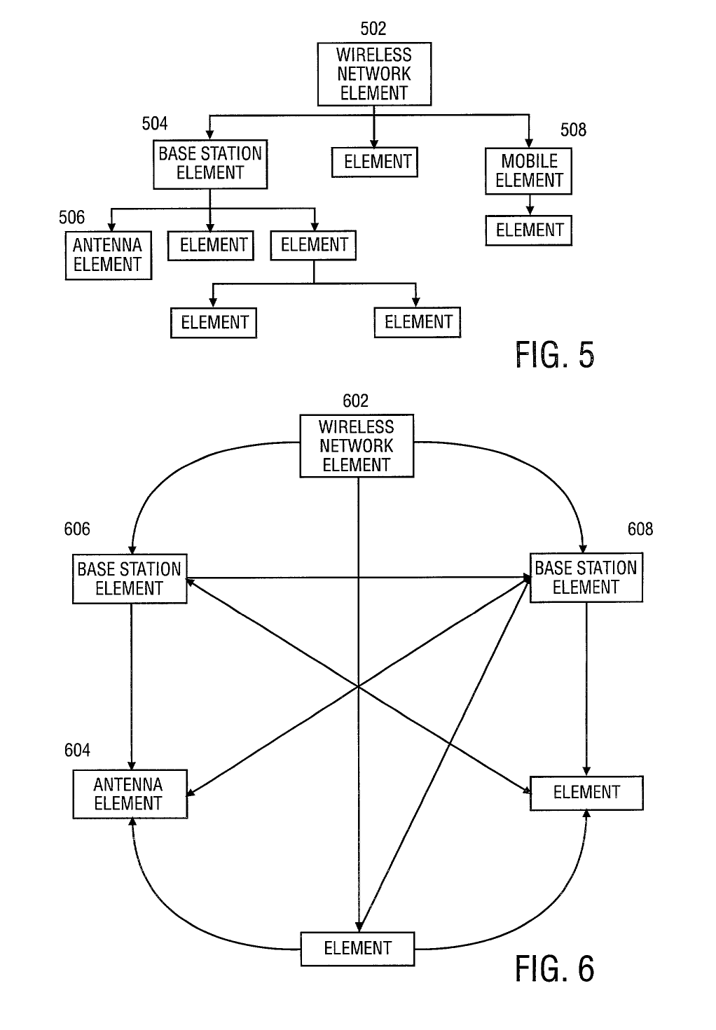

FIG. 5 illustrates an embodiment of a hierarchal tree-structure of inter-related elements. In general, an element refers to other elements. The element may require the use of services or actions of other elements, or the element may logically contain (or be contained by) other elements. The reference to other elements is implemented using data within each element. This can be implemented in several ways, including pointers to the other elements, indices into a global list of elements, or in some other similar way. Elements may have a containment, or parent-child relationship with sub-elements. The child elements have a lifetime identical to that of their parents. In an embodiment, the parent element may be a wireless network element 502. The second element, a child of the wireless network element 502, may be a base station 504. A child element of the base station 504 may be an antenna element 506. The fourth element, a mobile element, may also be a child of the first element, the wireless network element 502. The base station element 504 and the mobile element 508 exist in separate branches of the wireless network family tree. In an embodiment, this type of relationship is handled separately, allowing automatic lifetime management of the elements. The relationship between elements may also be any kind other than that of the parent-child relationship.

FIG. 6 illustrates a non-hierarchal arrangement of inter-related elements. The second type of relationship may include a potentially changing list of other elements whose services and actions are required by the element. The interaction of elements may involve the use of each other's services, and the exchange of data or messages. The data and messages may be generic containers of data specific to the sending and receiving element behaviors. The mobile element 608 exists on the same level as the wireless network element 602, antenna element 604, and the base station element 606. Each element may interact directly with every other element without having to travel a hierarchal route to interact with the child elements of another element. In general, both types of element relationships may coexist within a container application. Because the relationships are implemented as data entries, the relationships are completely flexible and dynamic, and can even be specified as data external to the software.

In an embodiment, a reverse bookkeeping strategy is used to insure that when an element is destroyed, the element is removed as a reference from all the elements that refer to the removed element. In an embodiment, removal of an element is achieved within each element by maintaining a list of all lists belonging to other elements in which the element is referenced. In an alternative embodiment, an external data structure having a cross-reference scheme could be used. The cross-referencing scheme links a first element with each of the elements that refer to the first element.

As stated above, elements may be simply collections of attributes and behaviors, with generic element-level functions designed to manipulate those attributes and behaviors. In addition, elements typically have additional functions and data to identify each element instance (such as a globally unique identification). Elements themselves may have no useful functionality apart from the behaviors contained by them. The element's type is defined by the types of the behaviors contained in the element. Similarly, the classes of the behaviors contained within the element define an element's class. An element may be comprised of an arbitrary collection of behaviors. An element's type, class, and thus the element's functionality are arbitrary. More importantly, due to the nature of component software architecture, the element may be constructed at runtime. The behavior classes in the element define the structural description of each element. The structural description of each element is specified by data known as the element's meta-data. This meta-data is used at run time (or even during the running of the container application) to retrieve the behavior components, initialize them and assemble them into an element. In the initialization phase, the attributes of the element can also be dynamically created and initialized. The meta-data may be given in any suitable text or binary format, including eXtensible Markup Language (XML), or a database. New functionality may be added by installing or adding new behavior components and/or creating new element types or classes in the meta-data.

A pattern that specifies both behavior types and classes may be thought of as a template for an element. A template can be used as a reference to create elements from the specified service components. Note that templates can have sub-templates. The element class catalog may be comprised of templates, or the element class catalog may be comprised of element instances, each corresponding to a distinct template.

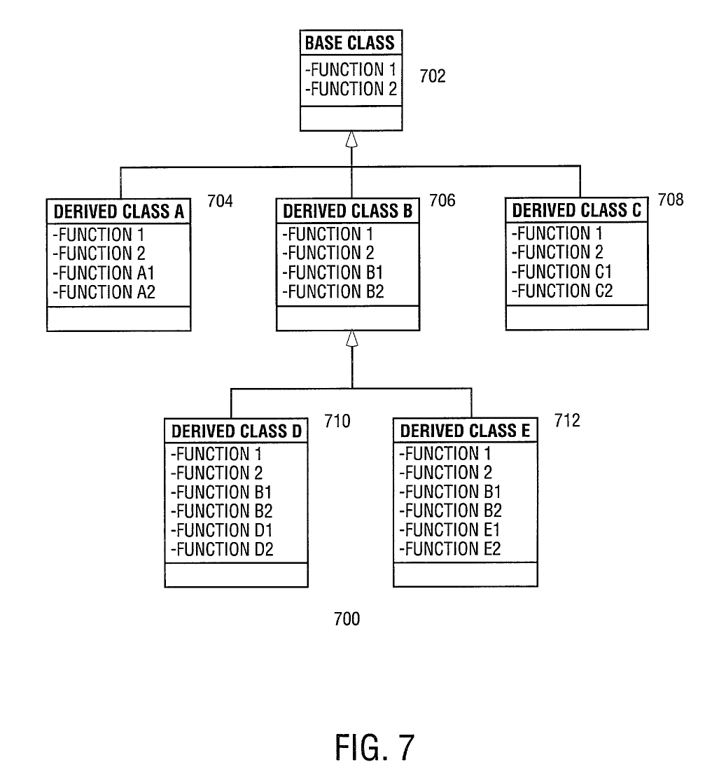

FIG. 7 illustrates an embodiment of a hierarchal tree-structure 700 representing class derivations. A base class 702 contains the functions labeled “Function 1” and “Function 2.” Function 1 and Function 2 have an implementation as well as an interface for those functions in the base class 702. Derived from the base class 702 are the derived class A 704, derived class B 706, and derived class C 708. Because of their derivation relationship with the base class 702, function 1 and function 2 are also defined for derived class A 704, derived class B 706, and derived class C 708. The derived classes may override function 1 or function 2, or they may by default reuse the implementations provided by the base class 702. In addition to the functions “Function 1” and “Function 2”, each of the derived classes adds functions that include interfaces and implementations. Derived class A 704 adds functions A1 and A2. Derived class B 706 adds functions B1 and B2. Derived class C 708 adds functions C1 and C2. Derived class D 710 and derived class E 712 also exist and are derived from derived class B 706. Derived class D 710 and derived class E 712 also add functionality, functions D1 and D2 and functions E1 and E2 respectively, to those functions inherited from derived class B 706.

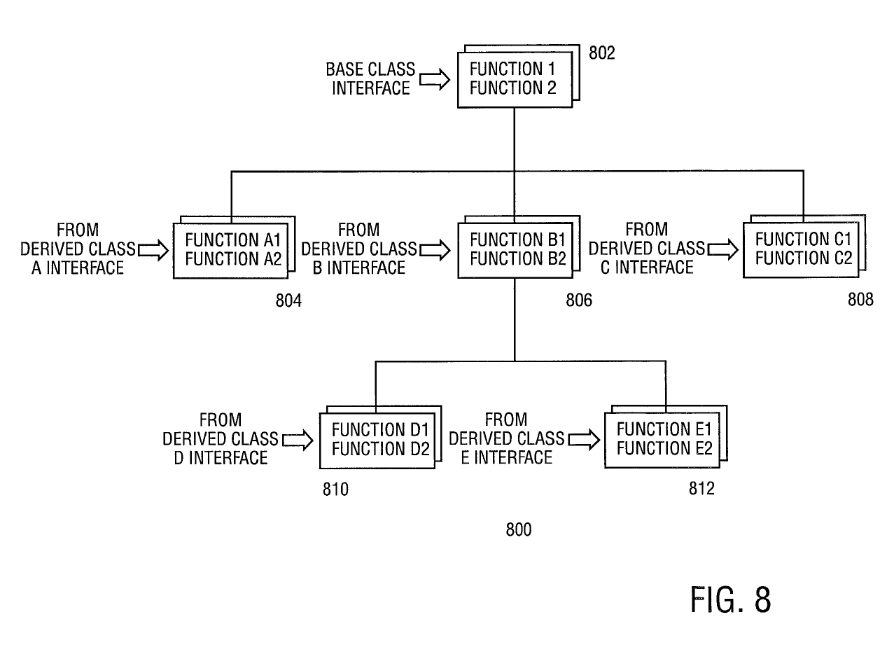

FIG. 8 illustrates a tree structure 800 of the increment of interface and implementation provided by each class. For each node in the tree in FIG. 7, there is a corresponding node in the tree in FIG. 8. In FIG. 8, the top-most box represents the functionality the base class 802 provides to a client. This functionality can be represented by the interface. The interface is defined by the base class 702. As we move to the next level in the tree of FIG. 8, we do not see the derived class A 704, derived class B 706, and derived class C 708 themselves as we did in FIG. 7, but rather the increment in functionality that derived class A interface 804, derived class B interface 806, and derived class C interface 808 provide with respect to their base class interface 802. And similarly, the lowest level boxes in FIG. 8 represent the increment in functionality provided by derived class D interface 810 and derived class interface E 812 with respect to their base class, B 806. The overall functionality (or interface) of a derived class corresponding to a particular node in the tree of FIG. 8 is the set of all the interfaces at this particular node and the interfaces of this particular node's ancestors in the tree.

The derived classes inherit the interface of their base class, but may inherit or override the implementation of their base classes. Each box in FIG. 8 may be an interface specification and a set of all the implementations of that interface. Thus, a class corresponding to a given node in the tree can be an assembly of implementations, each corresponding to the interface at its node and that of all its ancestors in the tree. This model is already somewhat more flexible than the traditional tree structure supported by OOP, since the implementation inheritance of a derived class need not be restricted to the class's direct parent but may be chosen arbitrarily from any implementation matching the required interface. In FIG. 8, a box represents an instance of a class D 810. The instance of class D is comprised of a set of implementations, each of which corresponds to an interface required by the overall class D interface 810.

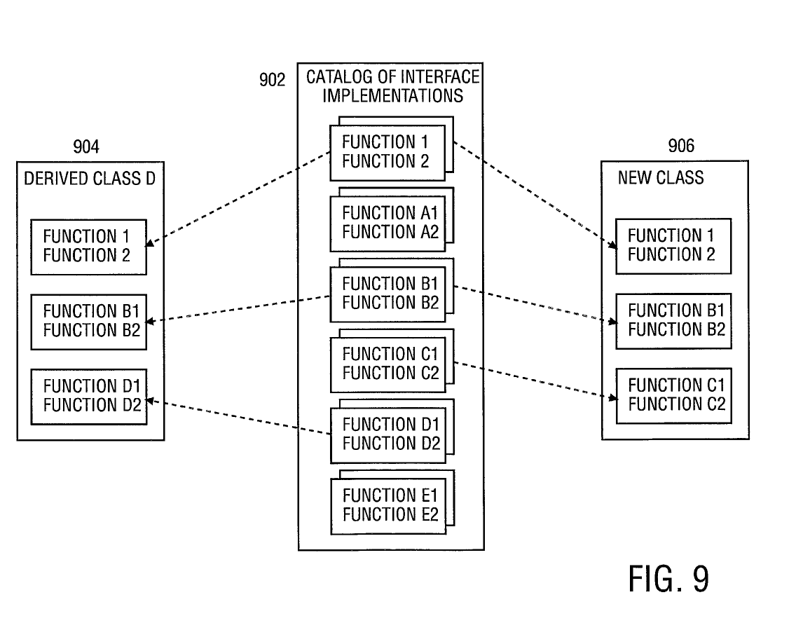

FIG. 9 illustrates a software component assembled from a catalog of all the available implementations of each interface. The application creator may define a class whose overall interface and implementation is created by assembly of an arbitrary set of implementations from the catalog 902 of available implementations. A derived class D 904 containing the functions identical to derived class D 810 from FIG. 8 may be assembled from the arbitrary set of implementations contained in the catalog 902 of available implementations. Thus the structure of the class can be created using a “Chinese menu” approach, rather than being constrained to a strict hierarchal inheritance of an interface. This concept is shown in FIG. 9, in which a “New class” 906 is assembled out of interface implementations, again drawn from the catalog 902. However, that this new class 906 does not belong in the object hierarchy as represented in FIGS. 7 and 8. The interfaces are drawn from the base class 802, as well as from derived class B 806 and derived class C 808.

The application creator is based on the strategy of generating software classes by assembling arbitrary collections of interfaces and implementations. This assembly process occurs at runtime thanks to the component architecture. We refer to the classes so generated as an element, and the assembled software implementations as behaviors. Elements are essentially a generic data structure, since we treat them as containers of behaviors and associated data. The client code then uses the elements not directly as specific types (as in OOP). Rather, the client code interacts with the element through its contained behaviors. A specific behavior of an element represents a context in which the client code deals with it. Put another way, the client code does not need to know, and does not care, what the element is in totality, but rather whether or not it supports the behavior that the client code wishes to use at the time.

In an embodiment, the use of these elements allows the application creator to achieve the following. Code reuse is maximized, since existing code can be assembled as behaviors into elements as desired. The software can readily be extended by adding behaviors. Also, old behaviors can be replaced with new behaviors with the same interface completely transparently. As mentioned above, there is no longer an enforced tree-structure required to allow code reuse. Finally, since the elements are assembled at run-time, the version of the container application is irrelevant. The versions of behaviors can change as long as they implement the same interface. Also, the code for the persistence of elements can be written once and for all, since they are entirely generic. If the contained behaviors have version-dependent data, however, they will be required to separately manage their own persistence issues.

In an embodiment the architecture of the container application supports both implementation inheritance and inheritance interface. In implementation inheritance, a derived object inherits the actual code of the base object. The derived object need not reimplement this code, but can instead directly use and build upon the code that is in the object. In interface inheritance, on the other hand, the derived object inherits nothing more than the definition of the interface of the base class, e.g., the names and parameters lists of the methods in the base class. Using the same definition guarantees some commonality between base class and the derived object. Also, using the same definition allows the client code to use a base class or a derived class without knowing the type of class. However, interface inheritance requires the derived object to reimplement all of the methods in the inherited interface (or at least to explicitly call the methods in the base class when needed). Interface inheritance does not allow a derived object to automatically reuse the existing code in the base class.

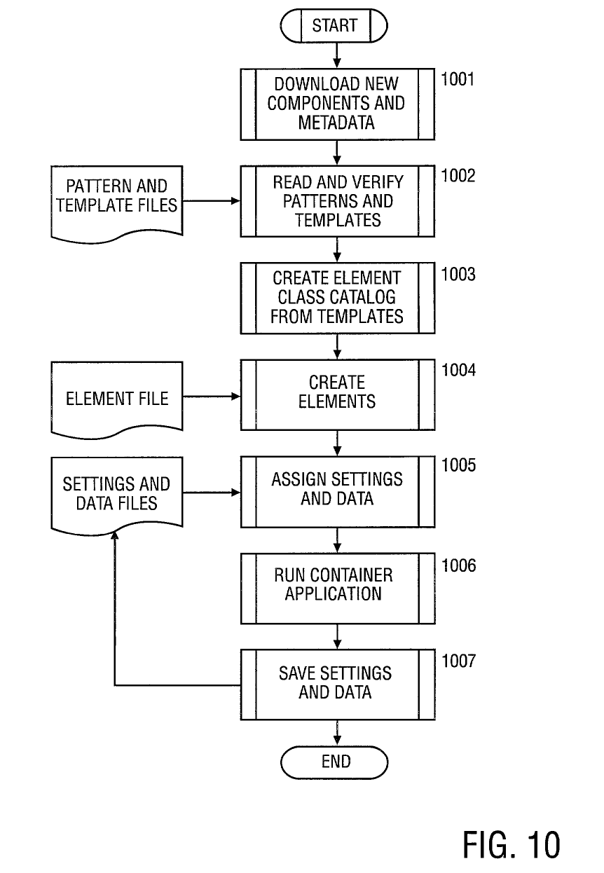

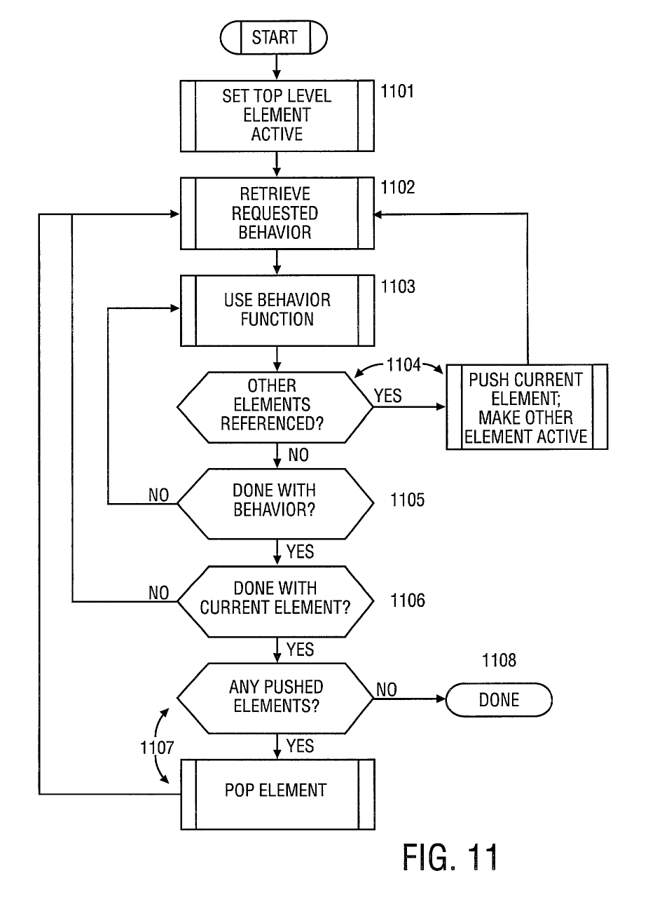

The operation of an embodiment of the application creator is depicted in the flowcharts in FIGS. 10 and 11.

FIG. 10 illustrates an overview of run-time software assembly and running of an embodiment of the container application.

In step 1001, the container application downloads new software components (implementing behaviors), and meta-data needed to assemble the elements. The components and/or data may be provided over the Internet, via some storage medium such as CD-ROM, or via a wireless transfer from an intelligent cell phone or personal digital assistant. Alternatively, a separate program could be used to download the components and meta-data. Meta-data may also be generated by defining new element classes from existing behaviors and new or existing attributes.

In step 1002, a meta-data file containing patterns is optionally read by the container application. The named patterns in the file can be used by elements in their linking and communications with other elements. The content of the meta-data files can be verified and check for accuracy. In an embodiment, XML may be used for the meta-data files, and DTD or schema can be used to help verify the meta-data file format.

In step 1003, element templates may be read from a meta-data file, or extracted from the patterns previously read. In an embodiment, the templates represent all the elements that the container application can create. In an embodiment, the container application creates both templates and other patterns during the execution of the container application.

In step 1004, the container application reads a “World Configuration” file containing the elements to be created for the current execution of the container application. The elements may be specified by their patterns. The container application creates the elements, creates and assembles their behavior components, and initializes and sets the attributes as appropriate.

In step 1005, optionally, additional files including values for the data and settings may be read. At this point the container application may enforce any containment or cross-referencing of the elements based on information in the World Configuration file. Again, this may be achieved using XML and DTD or schema.

In step 1006, the container application starts the main flow of execution by calling on a required service of a required element. In general, the required element is a top-level element that controls the execution. The execution continues as elements use each other's behaviors. This continues until no further behaviors are requested.

In step 1007, finally, information about the elements may be saved to disk, or other permanent medium to facilitate persistence.

FIG. 11 shows a detail of the running of an embodiment of a container application.

In step 1101, the top level element is set active.

In step 1102, the next requested behavior of the active element is retrieved by the container application.

In step 1103, functions provided by the behavior are used by the active element.

In step 1104, if in the use of the current function, a behavior of some other element is referenced, push the current element. Fetch the new element, and make the new element active. Then go to step 1102.

In step 1105, if the active element is not done with the current behavior, go to step 1103.

In step 1106, if there are more requested behaviors for the current element, go to step 1102.

In step 1107, if there are any pushed elements, pop the next one and make the pushed element active, and go to step 1102. The pushing and popping of elements described in steps 1102-1107 may not be performed literally by the programmer, though it could be. Rather, the effect maybe achieved automatically when computer languages such as C++ make function calls to a new element's service.

In step 1108, end the program.

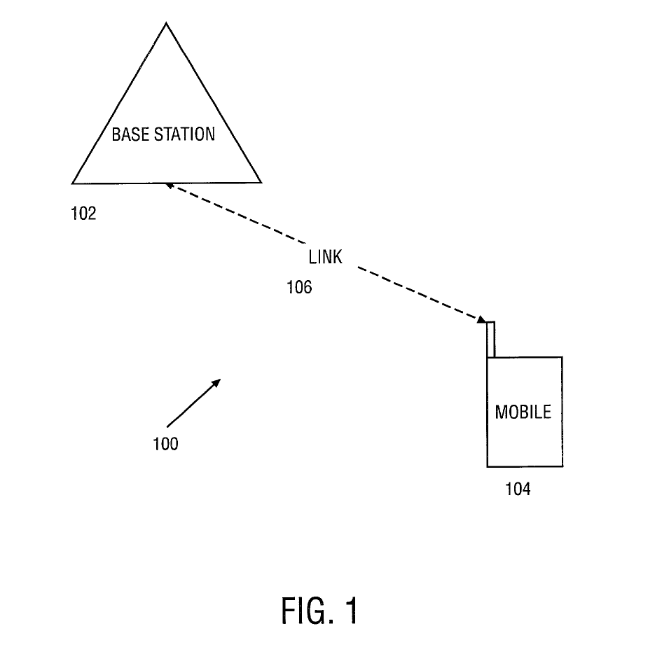

To clarify the concepts described above, a simple example will be given. Refer back to the simple Network as illustrated in FIG. 1. The software application will time-step a simulation of the signal strength of the Uplink (Mobile-to-Base Station) and Downlink (Base Station-to-Mobile). The Network will be displayed graphically by the application.

The software architecture lists the elements. The network itself will be represented by an element. The Network element has, as children, the Mobile element and the Base Station element. In addition, elements exist representing both the Uplink element and the Downlink element. The Mobile element owns the Uplink element, and the Base Station element owns the Downlink element. Finally, a top level element, World element, owns the Network element and contains the behaviors that are global.

| Element: | Parent Element: | Behaviors: |
|---|---|---|
| World | N/A | Analysis PropagationModel |
| Network | World | UpdateInTime Graphics |
| Base Station | Network | UpdateInTime Graphics |
| Mobile | Network | UpdateInTime Graphics |
| Uplink | Mobile | UpdateInTime Graphics |
| Downlink | Base Station | UpdateInTime Graphics |

By themselves, the elements have no functionality. To give them functionality, behaviors must be given to them. The world element has two behaviors. The Analysis behavior is responsible for managing the time-stepping of the simulation. The PropagationModel is responsible for computing the attenuation of the radio wave along the up and downlinks. All of the rest of the elements in this simple example have the same two types of behaviors. An UpdateInTime behavior, that time-steps the element, and a Graphics behavior, that does the drawing of the element in the graphical display. Notice that although the behaviors for all these elements are of the same type, they are not in general of the same class. That is, the interfaces are the same, but the implementations may differ. Because of this, in the following pseudocode, the behavior names are prefaced by the element that owns them.

The following pseudo-code demonstrates how the application would run:

main()
{

Element* pWorld = GetpWorld();
pWorld->Analysis->Run();

}
//
// World Behaviors
//
World::Analysis::Run()
{

// Retrieve the child element (it is the network)
Element* pNetwork = GetChild();
// Timestep the network
for (int n = 0; n < numTimesteps; n++)
{

pNetwork->UpdateInTime->Update();
pNetwork-> Graphics ->Display();

}

}
World::PropagationModel::ComputeLoss()
{

//
// Compute radio wave attenuation...
//

}
Network::UpdateInTime::Update()
{

// Timestep all of the child elements
while (Element* pElement = GetNextChildElement)
{

pElement->UpdateInTime->Update();

}

}
//
// Network Behaviors
//
Network:: Graphics::Draw ()
{

// Network specific drawing
// ---
//
// Draw all of the child elements (BaseStations and Mobiles)
while (Element* pElement = GetNextChildElement)
{

pElement->Graphics->Draw();

}

}
//
// BaseStation Behaviors
//
BaseStation::UpdateInTime::Update()
{

// BaseStation specific updates
UpdatePower();
// --- etc.
// Timestep all of the child elements (The downlink)
while (Element* pElement = GetNextChildElement)
{

pElement->UpdateInTime->Update();

}

}
BaseStation:: Graphics::Draw ()
{

// BaseStation specific drawing
// ---
//
// Draw all of the child elements (The downlink)
while (Element* pElement = GetNextChildElement)
{

pElement->Graphics->Draw();

}

}
//
// Mobile Behaviors
//
Mobile::UpdateInTime::Update()
{

// Mobile specific updates
UpdatePower();
UpdatePosition();
// --- etc.
// Timestep all of the child elements (The uplink)
while (Element* pElement = GetNextChildElement)
{

pElement->UpdateInTime->Update();

}

}
Mobile:: Graphics::Draw ()
{

// Mobile specific drawing
// ---
//
// Draw all of the child elements (The uplink)
while (Element* pElement = GetNextChildElement)
{

pElement->Graphics->Draw();

| | } |
|---|---|
| } | |
| // | |
| // Uplink Behaviors | |
| // | |
| UpLink::UpdateInTime::Update() | |
| { | |
| | // Get pointers |
| | Element* pWorld = GetpWorld(); |
| | Element* pMobile = GetpMobile(); |
| | double loss = pWorld->PropagationModel->ComputeLoss(); |
| | double mobilePower = pMobile->GetData(“Power”); |
| | SetData(“SignalStrength”, mobilePower - loss); |
| } | |
| UpLink:: Graphics::Draw () | |
| { | |
| | // Link specific drawing |
| | // --- |
| | // |
| } | |
| // | |
| // | Downlink Behaviors |

//
Downlink::UpdateInTime::Update()
{

// Get pointers
Element* pWorld = GetpWorld();
Element* pBaseStation = GetpBaseStation();
double loss = pWorld->PropagationModel->ComputeLoss();
double baseStationPower = pBaseStation->GetData(“Power”);
SetData(“SignalStrength”, mobilePower - loss);

}
Downlink:: Graphics::Draw ()
{

// Link specific drawing
// ---
//

}

Timestep all of the child elements (The uplink) while (Element*pElement=GetNextChildElement){pElement→UpdateInTime→Update( );}}

Mobile:: Graphics::Draw ( )

{//Mobile specific drawing// - - - // //Draw all of the child elements (The uplink) while (Element*pElement=GetNextChildElement){pElement→Graphics→Draw( );}}

// //Uplink Behaviors//UpLink::UpdateInTime::Update( )

{//Get pointers Element*pWorld=GetpWorld( ); Element*pMobile=GetpMobile( ); double loss=pWorld→PropagationModel→ComputeLoss( ); double mobilePower=pMobile→GetData(“Power”); SetData(“SignalStrength”, mobilePower−loss);}

UpLink::Graphics::Draw ( )

{//Link specific drawing // - - - //}

// //Downlink Behaviors//Downlink::UpdateInTime::Update( )

{//Get pointers Element*pWorld=GetpWorld( ); Element*pBaseStation=GetpBaseStation( ); double loss=pWorld→PropagationModel→ComputeLoss( ); double baseStationPower=pBaseStation→GetData(“Power”); SetData(“SignalStrength”, mobilePower−loss);}

Downlink:: Graphics::Draw ( )

{//Link specific drawing // - - - //}

The container application retrieves the Analysis behavior of the world. The “Run” function of the analysis is then called. The Analysis::Run( ) function loops some number of timesteps. At each timestep, the container application updates the network in time by calling the Update( ) function in the UpdateInTime behavior located in the network element. In order to refresh the network's display, the container application then calls the Display( ) function of the network's Graphics behavior. The analysis is acting as the client code in the Run function; the client code need know nothing about the network element, other than that the network element has the UpdateInTime behavior and Graphics Behavior.

Both the UpdateInTime::Update function and Graphics::Display functions for each element are handled by local, element-specific code, and then passed on to the matching behaviors in the element's child elements. The thing that makes the mobile element a mobile element is not the basic type of the class representing the mobile element (since all objects here are represented by elements), but rather that the behaviors are mobile-like behaviors.

The simple network example above can also be used to illustrate an example of a business use for the application creator. Assume a customer uses the network simulation application above. Then a new technology, such as a new form of power control for Mobiles is created. The creator of the new power control mechanism can write the new UpdateInTime behavior that models this new power control, subject to the published interface definition of that behavior. This new behavior could replace, or use (via containment delegation or aggregation) the old behavior. The customer of the software application could download the new behavior, and a new meta-data specification of the behaviors contained by a mobile element. The customer could then immediately run the application with the new power control behavior linked in automatically at run time. All this could happen without requiring the creator of the original application to intervene in any way. The creator of the new technology only had to write code for the control behavior. Further, anyone interested in the new technology, could readily run the new technology on their existing software platform.

In prior software techniques, components are used as building blocks. Each component fulfills a pre-planned, well-known purpose for the client software. In an embodiment, the application creator assumes no pre-determined functionality on the part of the software components that the application creator assembles at run-time. The application creator does not require a predetermined functionality of the application that the application creator assembles. The result is unprecedented flexibility and extensibility of the resulting application.

The invention is to be understood as not limited by the specific embodiments described herein, but only by scope of the appended claims.

What is claimed is:

1. A method, comprising:
reading meta data to assemble components at run time to create an element; and
executing a container application, the container application interacting with the element with respect to a behavior contained by the element.

2. The method of claim 1, further comprising:
using a pattern in the meta data for linking between elements;
using a pattern in the meta data for communications between elements; and
creating an element class catalog from a template.

3. The method of claim 1, further comprising:
assigning values for a setting in the element;
assigning values for data in the element; and
saving information about the element to a computer readable medium.

4. An apparatus, comprising:
an application creator to assemble software components at run time into a container application, the container application to support interface inheritance and implementation inheritance from an existing software component.

5. The apparatus of claim 4, wherein the container application comprises:
an element container;
a catalog of available interfaces and implementations;
element coordination logic; and
an element.

6. The apparatus of claim 5, wherein the element is one in a group consisting of a representation of a specific object, or a logically distinct set of functions used by the container application.

7. The apparatus of claim 4, wherein implementation inheritance is one in a group consisting of reusing code from the existing software component, selectively overriding an individual function defined by the existing software component, adding a new function to the existing software component that is automatically propagated to a derived software component, or composing new elements from existing behaviors.

8. The apparatus of claim 4, wherein the container application comprises a simulation.

9. The apparatus of claim 4, wherein the container application comprises a simulation of a communications system.

10. The apparatus of claim 4, wherein the container application comprises a simulation of a wireless network.

11. The apparatus of claim 4, further comprising the container application to support an addition of a new function to the container application without having to recompile the container application.

12. The apparatus of claim 4, further comprising the application creator to enable creation of an application without the program having a predetermined functionality.

13. The apparatus of claim 5, wherein the element further comprises the element having an attribute and a behavior.

14. The apparatus of claim 13 wherein the attribute is one in a group consisting of data, part of a definition of the element, or a description of a state of the element.

15. The apparatus of claim 13, wherein the behavior comprises an implemented function.

16. The apparatus of claim 13, further comprising the behavior having an interface defining a type of behavior.

17. The apparatus of claim 13, further comprising the behavior being a service.

18. A method, comprising:
assembling software components at run time into a container application to make a coherent application;
selecting an interface and an implementation from a catalog; and
using the interface and the implementation with the container application.

19. The method of claim 18, further comprising:
reusing code from an existing software component.

20. The method of claim 18, further comprising:
selectively overriding a function inherited from an existing software component.

21. The method of claim 18, further comprises:
composing new elements from existing behaviors.

22. The method of claim 18, further comprising:
automatically propagating to a derived class a new function added to a base class.

23. The method of claim 18, wherein the container application interacts with the software component with respect to a behavior contained by the software component.

24. The method of claim 18, wherein the container application supports a file irrespective of a version of the container application.

25. The method of claim 18, wherein the application comprises a simulation.

26. An apparatus, comprising:
a computer readable media; and
a program embedded on the computer readable media and written in component software language, the program to provide instructions, which when executed by a machine, cause the machine to assemble an arbitrary collection of elements at run time into an application, the application uses an arbitrary assembly of interfaces and implementations, and the application supports implementation inheritance and interface inheritance from a class.

27. The apparatus of claim 26, wherein the application interacts with the element with respect to a behavior contained by the element.

28. The apparatus of claim 26, wherein the application comprises a simulation.

29. A apparatus, comprising:
means for assembling software components at run time into a container application to make a coherent application;
means for selecting an interface and an implementation from a catalog; and
means for using the interface and the implementation with the container application.

30. The apparatus of claim 29, further comprising:
means for reusing code from an existing software component.

31. The apparatus of claim 29, further comprising:
means for selectively overriding a function inherited from an existing software component.
